(19) United States
(12) Patent Application Publication
(10) Pub. No.: US 2021/0129504 A1
(43) Pub. Date: May 6, 2021

(54) COMPOSITE SUBSTRATE AND METHOD FOR PRODUCING SAME

(71) Applicant: LIFEWOOD INTERNATIONAL PTY LTD, Osbourne Park (AU)

(72) Inventor: Mark HUTCHISON, Osbourne Park (AU)

(73) Assignee: Lifewood International Pty Ltd, Osbourne Park (AU)

(21) Appl. No.: 17/041,900

(22) PCT Filed: Mar. 27, 2019
(86) PCT No.: PCT/AU2019/050275

§ 371 Date: Sep. 25, 2020

(30) Foreign Application Priority Data
Mar. 27, 2018 (AU) 2018901018

(51) Int. Cl. B32B 21/10; B32B 3/18; B32B 21/02; B32B 9/02; B32B 3/06; B32B 21/13; B32B 9/04; E04F 15/02; E04F 15/04

(52) U.S. Cl. CPC B32B 21/10; B32B 3/18; B32B 21/02; B32B 9/02; B32B 3/06; B32B 21/13; E04F 2201/023; E04F 15/02038; E04F 15/045; B32B 2250/03; B32B 2262/065; B32B 2419/04; E04F 2201/044; B32B 9/042

(57) ABSTRACT

A composite substrate is disclosed. In one embodiment, the composite substrate comprises an inner part (20) arranged intermediate first (10) and second (15) outer members, the inner part comprising more than one segments (22) orientated so that fibres of at least one segment align substantially transverse to fibres of one or both of the first (10) and second (15) members, the relative alignment of the respective fibres serving to, at least in part, align prospective deformation of the or each segments (22) and at least one of the first (10), second (15) outer members in a common direction. A method for producing at least one embodiment of the composite substrate is also disclosed. In another aspect, a floorboard is produced using the composite substrate.

### FIELD OF THE INVENTION

A composite substrate and method for producing same as disclosed.

### BACKGROUND

Any references to documents that are made in this specification are not intended to be an admission that the information contained in those documents form part of the common general knowledge known to a person skilled in the field of the invention, unless explicitly stated as such.

Discussion of the background to the invention is intended to facilitate an understanding of the present invention only. It should be appreciated that any such discussion is not an acknowledgement or admission that any of the material referred to was published, known or part of the common general knowledge of the person skilled in the art in any jurisdiction as at the priority date of the invention.

There is a demand for timber floorboards as a type of flooring in homes. Floor boards can be characterised as three types, a solid unitary board cut to size from a log, or a particle/fibre board, or a composite board formed of layers that are glued together.

The solid unitary board have a good finish and are desired because of the solid feel. However, they are wasteful of wood in a log that does not meet adequate visual requirements and they are expensive. They are also vulnerable to deformation such as cupping, crowning and shrinkage, due to inherent internal stresses and external factors, such as temperature and humidity.

The particle boards are sometimes less desired because they do not have a natural grain finish.

Composite boards can suffer from problems arising from different expansion and/or contraction, typically due to differences in moisture exposure, between the top and bottom layers. This in turn can lead to cupping and crowning. They can also be susceptible to other problems such as checking, colour changes, and gapping.

Market pressures desire a flooring product that has a natural gain appearance, is wider, if prefinished and is not subjected to deflection over time (stays flat). It is difficult to meet these demands and still compete on price. As a result of low cost and availability of materials used in composite flooring solutions, compromises are made in the inherent strength of the products used. Softwood products generally have low deflection strengths requiring increased thicknesses in order to provide sufficient strength to minimise movement such as cupping. Wider, thin products are susceptible to distortion over time. Alternatively, as products get wider they are made thicker to compensate for increased stresses in the upper layer. Thicker products result in a higher volume of materials required, which as a cost impact.

A need exists to develop a composite substrate capable of being used in the flooring industry and which seeks to address various of the diverse scope of constraints in this complex and changing market. It is against this background that the embodiments described herein have been developed.

### SUMMARY

According to a first principal aspect, there is provided a composite substrate comprising:
an inner part arranged intermediate first and second outer members at least one of which is made of a first material, the inner part comprising more than one segments of a second material that is different to the first material orientated so that fibres of the second material at least one segments align substantially transverse to fibres of the first material of one or both of the first and second outer members, the relative alignment of the respective fibres serving to, at least in part, align prospective deformation of the or each segments and at least one of the first, second outer members in a substantially common direction.

Preferably, the first material is timber. More preferably, at least an upper member of the outer members is timber.

According to a second principal aspect, there is provided a composite substrate comprising one or more inner parts of a bamboo material arranged intermediate first and second outer members at least one of which is made of a wooden material, the or each inner part being orientated relative to the first, second outer members such that respective directions in which any of the or each inner parts and the first, second outer members may physically respond are substantially aligned.

The composite substrate of the above described principal aspects may be used to provide improved composite structures for use in producing panels for various applications. By way of brief examples, such composite substrates may be used for providing, for example, floorboard panels for use in flooring assemblies, ceiling board/panels for use in ceiling assemblies, and/or wall board/panels for use in wall assemblies. When configured in the described manner, improvement is sought, at least in part, in the stability (eg. non-uniform deformation in multiple axes of the respective components/members comprising the composite substrate) of the structure, and/or resistance to the ingression of moisture/water.

The above described principal aspects, and those described below, may comprise any of the following features:

Optionally, the first and second outer members comprise timber cut from a log. In an embodiment the fibre direction of the outer members is indicated by a grain direction of the timber.

Optionally, the inner part and first, second outer members may be respective layers of desired material combined together to form the composite substrate.

Optionally, the inner part comprises an assembly of bamboo segments or sections. In one embodiment, the segments comprise a high density bamboo based substrate. In another embodiment, the segments comprise bamboo based orientated strand board. In this manner, the composite substrate can benefit from the deflection resistance properties of oriented strand board.

Optionally, the composite substrate can be configured to be of variable thickness or length. It will be understood by the skilled reader that the dimensions of the composite substrate and its constituent components can be configured as required.

Optionally, one or more portions of the segments not covered by the first, second outer members are covered by portions of one or more elements. In this manner, areas of the segments that might be exposed by way of not being covered by either of the first or second outer members becomes covered. At least one advantage of this configuration is for the purposes of reducing prospective exposure to ambient conditions, which could be relatively high in moisture. Optionally, the or each element may be elongate in nature, and/or of uniform cross-section along its length.

Optionally, the composite substrate comprises a pair of elements (which could be provided, for example, in the form of a pair of strips of material) disposed at least partially between the first and second outer members and arranged against opposite sides of a portion (or segment) of the inner part in a substantially co-planar manner.

Optionally, a portion of the inner part is located intermediate the pair of elements.

Optionally, the one or more of the elements comprises strips of bamboo based oriented strand board (OSB), plastic, or timber.

Optionally, the composite substrate may comprise one or more components of an interlocking feature for the purposes of allowing the relative positional securement. In this manner, such an interlocking feature may allow the composite structure to engage with, for example, another structure.

Optionally, one or both of the pair of elements may be a component of the interlocking feature.

In one embodiment, for example, for the case where the composite structure is exemplified in the form of a floorboard, the interlocking feature may provide one or more components which provide a ‘tongue and groove’ arrangement allowing like configured floorboards to be secured to each other for providing a flooring assembly.

Optionally, one edge of the composite substrate provides a recess (eg. a groove feature) configured for seating substantially therein a projection (eg. a tongue feature) provided by an edge of another but like composite substrate.

Optionally, the recess and projection are configured of complimentary shape and/or form. In this matter, the projection seats within the recess sufficient for achieving an engaged and/or interlocked condition.

Optionally, another edge of the composite substrate provides a projection substantially identical to the projection provided by the edge of said another but like composite substrate.

Optionally, the interlocking feature, or one or more components thereof, may be provided of any suitable material.

The skilled reader will appreciate that other forms of interlocking arrangements (being complementary or otherwise) may be configured to operate with various embodiments of the composite substrate described herein.

Optionally, one or both of the first and second outer members are capable of physical response in a direction not substantially aligned with a fibre direction of the respective first, second outer members. One or more of the or each of the segments or portions of the inner part are capable of physical response in a direction substantially aligned with a fibre direction of each respective segment or portion. Each segment or portion of the inner part is aligned relative the first, second outer members such that the directions of respective physical responses are substantially aligned. In this manner, improved stability of the structure can be sought when alignment of the directions in which each of the segments of the inner part and the first, second outer members physical response is achieved. In this manner, prospective physical responses (such as for example, deformation) of the or each segments and/or at least one of the first, second outer members can be aligned in a substantially common direction.

Optionally, the physical response of the first and second outer members comprises an expansion or contraction. In an embodiment the physical response is transverse to a length of the first and second outer members.

Optionally, the physical response of one or more segments of the inner part comprises an expansion or contraction. In an embodiment the physical response is aligned with a length of the inner part. Advantageously, in an embodiment, this physical response is aligned transverse to the length of the first and second outer members.

Optionally, the inner part comprises side by side segments, where each segment has a length and a width, where the width is of a similar dimension to the length. In an embodiment the lengths are transverse to a length of the first and second outer members.

Optionally, expansion or contraction of the first and second outer members, or one or more segments of the inner part is in response to the first, second members, or the one or more segments of the inner part becoming subject to any of the following: a thermal load, moisture, humidity or water.

Optionally, the inner part is arranged such that relaxation following (for example due to) compression is substantially in a direction transverse to the length of the inner part. Preferably the relaxation is also substantially in a direction transverse to a width of the inner part. Typically, the relaxation is substantially in a direction parallel to a thickness of the inner part.

In an embodiment a lower one of the first and second outer members comprises plastics.

According to a third principal aspect, there is provided a floor board comprising a first outer timber layer, a second inner bamboo layer, and a third outer timber layer.

In an embodiment the first and third timber layers are of the same type of timber, however in an alternative, they are of different types of timber. In an embodiment the second inner bamboo layer comprises a plurality of side by side segments. In an embodiment the bamboo layer has a fibre/grain direction transverse to the fibre/grain direction of the first and third timber layers. In an embodiment the inner bamboo layer has a direction of expansion due to compression relaxation that is transverse to a plane through which the inner bamboo layer extends.

According to a fourth principal aspect, there is provided a substrate comprising a length, a width and a thickness; a pair of edge strips running the length of the substrate, and which define the width of the substrate, and which have a height that defines the thickness of the substrate; a plurality of segments extending between, and glued/adhered to, the edge strips in a manner so as to be side by side along the length of the substrate; wherein the strips have a height substantially the same as the thickness of the substrate; wherein the segments are formed of bamboo, and have a fibre direction extending transversely to the length of the substrate; wherein the strips have a direction of expansion due to compression relaxation that is transverse to the fibre direction and transversely to the length of the substrate.

In an embodiment a layer of wood is attached to one of the major surfaces of the substrate, where the grain of the wood extends substantially parallel to the length of the substrate. In an embodiment a top layer of visually first grade wood is attached to a first major surface of the substrate. In an embodiment a bottom layer of visually second grade wood may be attached to an opposite second major surface of the substrate.

According to a fifth principal aspect, there is provided a method for forming a composite substrate, the method comprising:
providing a bamboo based substrate,
modifying the substrate to provide more than one separate segments,
combining more than one of the segments so that respective fibre directions of the segments are aligned substantially parallel to each other,
modifying the combined segments to provide one or more separate layers, and
locating one of the separate layers so formed between first and second outer members in a manner whereby the direction of the fibres of one or both of the first and second outer members are aligned substantially transverse to the respective fibre directions of the segments.

Optionally, the first and second outer members are formed of timber cut from a log.

Optionally, the first and second outer members have a direction of physical response that is substantially in the same direction to the direction of physical response of segments.

Optionally, the step of providing a bamboo based substrate comprises forming a high density bamboo based substrate.

Optionally, the step of providing a bamboo based substrate comprises one or more of the processing steps for producing orientated strand board. In this manner, raw bamboo material may be subject to any of the following treatments/processes:
treating/soaking the bamboo fibres with a resin (eg. soaking in a Phenolic resin) in order to increase fibre stability and water resistance;
orientating the bamboo fibres so that they align substantially parallel to surfaces that are potentially exposed to moisture;
compressing the fibres so as to reduce their water transfer properties;
subjecting the fibres to drying process, such as for example by heating.

Optionally, the step of providing a bamboo based substrate may involve soaking raw bamboo material in a resin (such as for example, a Phenolic resin) in order to increase the stability of the material and/or increase the material's resistance to water.

Optionally, the step of providing a bamboo based substrate comprises configuring said substrate having an elongate shape whereby a substantially uniform cross-section extends in a length direction of the substrate. In one embodiment, the uniform cross-section is substantially rectangular.

Optionally, the step of modifying the bamboo based substrate to provide a plurality of segments comprises cutting the bamboo based orientated strand substrate perpendicularly across the length direction of the bamboo based orientated strand substrate. Preferably the cutting is also transverse to a direction of compression of the oriented strand board, for example by back sawing. Typically, the segments will have their narrowest dimension parallel to the direction of compression.

Optionally, each of the segments are of similar shape and/or form.

Optionally, the step of combining more than one segments so that respective fibre directions of the segments are aligned substantially parallel to each other comprises rotating each of the segments so as to orientate the fibres of the segments so that their respective running directions align substantially with the width (i.e. transverse to the length direction of the combination of segments) of the bamboo based orientated strand substrate.

Optionally, the step of combining more than one segments comprises forming a combination of segments having an elongate shape with a substantially uniform cross-section (which, in one embodiment, may also be of rectangular form) extending in the length direction. In this manner, the direction of the fibres of the respective segments are substantially transverse to the direction of elongation of the combination of segments.

Optionally, the step of modifying the combination of segments to provide one or more separate layers comprises dividing (for example, by cutting) the combination of segments in a thickness direction thereof to provide the or each separate layers. In this manner, each of the separate layers may be of uniform cross-section along their length. In one embodiment, the uniform cross-section is substantially rectangular in form.

In one embodiment, the separate layers are approximately 7 to 9 mm in thickness.

Optionally, each of the separate layers may be subject to drying (such as for example, by heating in a kiln) in order to reduce moisture content for balancing purposes, or pressure loading.

Optionally, the step of locating one of the separate layers so formed between first and second members comprises fixing one of the separate layers between first and second members using adhesive or mechanical fastening means. In this manner, a ‘blank’ may be formed.

Optionally, following location of the first and second outer members to the respective separate layer, the combination of same is subject to any of the following: thermal loading for reducing moisture content (and balancing purposes to ensure consistency and accuracy), appropriate treatment for the purposes of improving the performance and/or aesthetics of the outer facing surface of either of the first or second outer members (for example, for the case of a composite floorboard produced by the present method, the surface intended to be visible to the consumer).

Optionally, following combining of the more than one segments, the method may comprise locating one or more elements against one or more respective sides of the combination of segments. In one embodiment, such locating comprises fixing (by, for example, adhesive or mechanical means) a respective element to a substantially planar face of the combination of segments (ie. a planar face that extends substantially parallel to the length direction of the combination of segments). In an embodiment, the respective side elements become side strips of the separate layers when modified to form the separate layers.

Optionally, a pair of elements may be located or fixed to opposite faces of the combination of segments. In this manner, the combination of segments is located in between the pair of elements. In one embodiment, the combination of segments is located in between the pair of elements such that the combination of segments and the pair of elements are in a substantially coplanar relationship.

Optionally, the or each elements is elongate and/or of uniform cross-section. Optionally, the or each elements is a strip of material which could comprise, for example, timber, plastic, or any suitable material to suit the intended application. Preferably the or each element comprises bamboo material. More preferably the or each element comprises the same type of bamboo material as the bamboo based substrate.

Optionally, the method may further comprise reusing wastage resulting from any modification stage using cutting techniques.

Advantageously, and without being bound by testing to date, embodiments of the principles exemplified herein seek a more cost-effective composite substrate (for example, for use in producing a floorboard or other like construction panel) exhibiting any of the following advantages: the substrate providing improved strength by design, being thinner in its thickness (as compared to solid and traditional manufacturing of engineered panels/boards), requiring less hardwoods resource, having improved termite and/or moisture resistance, and/or being more appealing to the consumer.

According to a sixth principal aspect, there is provided a method for forming a composite substrate, the method comprising:
providing a bamboo based substrate,
modifying the substrate to provide more than one separate segments,
combining more than one of the segments so that respective fibre directions of the segments are aligned substantially parallel to each other,
locating one or more elements formed of a bamboo based substrate against one or more respective sides of the combination of segments;
modifying the combined segments to provide a plurality of separate layers,
each layer being suitable for locating between first and second outer members in a manner whereby the direction of the fibres of one or both of the first and second outer members will be aligned substantially transverse to the respective fibre directions of the segments.

According to another principal aspect, there is provided a composite wooden panel comprising an inner part located between first and second wooden outer members, the inner part comprising more than one fibrous segments orientated so that fibres of at least one of the segments align substantially transverse to fibres of one or both of the first, second wooden outer members, the relative alignment serving to, at least in part, align the directions of prospective deformation of the or each segments and the first, second wooden outer members.

Preferably, the fibrous segments are formed of bamboo.

According to another principal aspect, there is provided a floor board comprising a first outer compressed bamboo layer, a second inner timber layer, and a third outer compressed bamboo layer.

In an embodiment the first and third bamboo layers have a fibre direction substantially transverse to a fibre/grain direction of the inner timber layer. In an embodiment the outer compressed bamboo layers are formed by back sawing. In an embodiment the compressed bamboo layers comprise a direction of relaxation of compression aligned with the thickness dimension of the floor board.

According to another principal aspect, there is provided a composite substrate produced using any embodiment or implementation of the method of the fifth principal aspect or as described herein.

According to a further principal aspect, there is provided a composite wooden laminate panel comprising, at least in part, any embodiment of a composite substrate operably configured according to the first or second principal aspects or as described herein.

According to another principal aspect, there is provided a floor comprising a covering of a plurality of composite wooden laminate panels comprising, at least in part, any embodiment of a composite substrate operably configured according to the first to fourth principal aspects or as described herein.

According to a further principle aspect, there is provided a method for forming a composite substrate, the method comprising:
providing a bamboo based substrate comprising a length, a width and a thickness; a pair of edge strips running the length of the substrate, and which define the width of the substrate, and which have a height that defines the thickness of the substrate; a plurality of segments extending between, and adhered to, the edge strips in a manner so as to be side by side along the length of the substrate; wherein the strips have a height substantially the same as the thickness of the substrate; wherein the segments are formed of compressed bamboo, and have a fibre direction extending transversely to the length of the substrate; wherein the strips have a direction of expansion due to compression relaxation that is transverse to the fibre direction and transversely to the length of the substrate; wherein the strips have a direction of expansion or contraction substantially as a result of environmental conditions that is substantially transverse to the length of the substrate,
fixing on each side of the bamboo based substrate first and second outer members in a manner whereby the direction of the fibres of one or both of the first and second outer members will be aligned substantially transverse to the respective fibre directions of the segments, wherein expansion or contraction of one or both of the first and second outer members substantially as a result of environmental conditions is substantially transverse to the length of the substrate.

According to a further principle aspect, there is provided a floor board comprising:
a bamboo based core comprising a pair of edge strips running a length of the floor board; a plurality of segments extending between, and adhered to, the edge strips in a manner so as to be side by side along the length of the floor board; wherein the segments are formed of compressed bamboo, and have a fibre direction extending transversely to the length of the floor board; wherein the strips have a direction of expansion due to compression relaxation that is transverse to the fibre direction and transverse to the length of the floor board; wherein the strips have a direction of expansion or contraction substantially as a result of environmental conditions that is substantially transverse to the length of the floor board,
a first outer timber member having fibres that are aligned substantially transverse to the
respective fibre directions of the segments, wherein expansion or contraction of one or both of the first outer member substantially as a result of environmental conditions is substantially transverse to the length of the floor board; and
a second outer member on an opposite side of the floor board to the first outer member.

According to a further principal aspect, there is provided a kit of parts comprising more than one composite wooden laminate panels each comprising, at least in part, any embodiment of a composite substrate operably configured according to the first to fourth principal aspects or as described herein.

Various principal aspects described herein can be practiced alone or in combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

In order to provide a better understanding of the principles described herein, one or more embodiments exemplifying said principles will now be described, by way of example only, with reference to the drawings, in which:

FIG. 1 shows a schematic perspective view of a portion of one embodiment of the composite substrate described herein;

FIG. 2 shows a plan view of the portion shown in FIG. 1 (with first outer member removed);

FIG. 3 shows a flow diagram of one embodiment or implementation of a method arranged for producing an embodiment of the composite substrate described herein;

FIG. 4 shows a schematic perspective view of various stages of the sequence of the method shown in FIG. 3;

FIG. 5A shows a schematic perspective view of one embodiment of a floorboard described herein with a portion of one of the outer members removed;

FIG. 5B shows a schematic perspective view of another embodiment of a floorboard described herein with a portion of one of the outer members removed; and

FIG. 5C shows a schematic perspective view of an end of one embodiment of a floorboard described herein.

### DETAILED DESCRIPTION

An embodiment of the improved composite substrate and method for making same will be described in the context of use in providing a floorboard used in a flooring assembly. While the embodiments described herein are outlined in the context of a floorboard, it will be appreciated by the skilled reader that the principles described herein can be used to provide composite structures for use in many other applications.

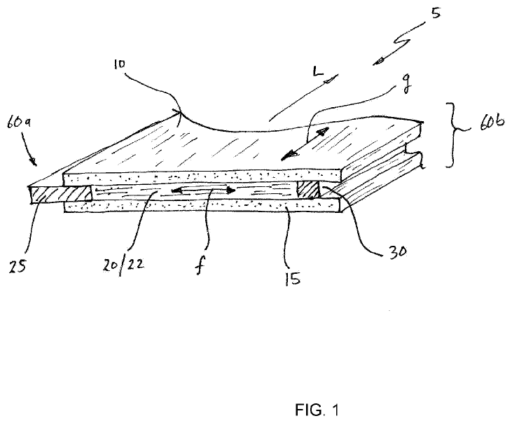

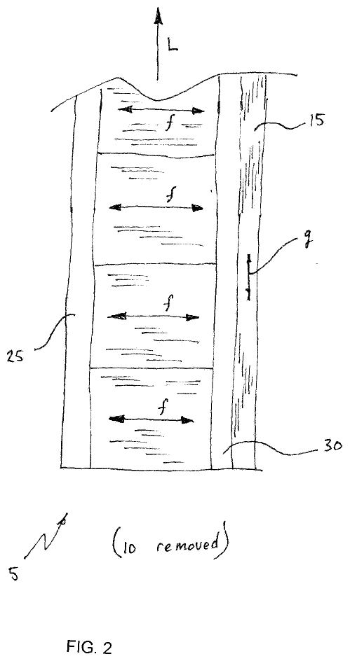

Accordingly, one embodiment of a composite floorboard 5 exemplifying the principles described herein is shown in FIGS. 1 to 2. The floorboard 5 comprises of a three layered sandwich composite substrate having a first 10 (upper) and second 15 (lower) outer members (both comprising timber, preferably cut from a log, rather than being chipboard or particle board) of about equal thickness (of about 2 to 6 mm), and an inner part 20 located intermediate or between the first and second outer members. It will be appreciated that the inner part 20 can range in thickness and is not necessarily equal to the thickness of the first 10 and second 15 outer members.

In the embodiment shown, the inner part 20 is formed from a substrate comprised of compressed (generally high density) bamboo fibre, wherein the fibres are generally uniformly aligned in the same direction. The inner part 20 comprises a plurality of block like segments or sections (referenced as 22a, 22b, and 22c in the portion shown in FIG. 2) of compressed bamboo orientated strand board (OSB) so that the general direction of the fibres (referenced f in each segment shown in FIGS. 1 and 2) of each segment 22 align substantially transverse to the direction of the fibres (referenced as g in FIGS. 1 and 2) of both the first 10 and second 15 outer members; the fibres g align in a length direction L of the structure shown. The relative alignment of the respective fibres f, g serve to, at least in part, align prospective deformation (for example, compression/expansion) of the segments 22 and the first 10, second 15 outer members in a common direction.

By this new configuration, adverse effects, such as for example shrinkage, surface movements such as cupping, checking, crowning, warping, and gapping, evident in some existing floorboard configurations when subject to various ambient conditions, can be reduced. Thus, embodiments of the composite substrate described herein seek to avoid difficulties when ‘cross engineering’ materials which may respond in different (and sometimes contrasting) ways (for example, directions) when subject to certain conditions or environments, eg. changes in heat, humidity etc.

By way of brief explanation, ‘cross engineering’ is a commonly used technique to increase the stability of a floorboard. Timber (fibre) expansion is mostly radial in nature relative to the tree log from which the timber is obtained. Thus, when cut from the log, the expansion (or contraction) is transverse to the fibre/grain direction, thereby creating an engineering restriction when using timber as a cross engineering material. The manifestation of this restriction is that with seasonal moisture variations, the timber of the upper and lower layers of existing floorboards will expand/contract across the width of the board (sometimes up to about 10%). Existing materials used as the inner part (sometimes referred to as the middle or core layers) will expand along the length of the board which can result in structural failure of the floorboard. Methods of overcoming this problem can result in middle or inner part layers (of, for example, less than about 40 mm wide) being used, typically with an expansion gap of about 1 mm to about 3 mm between sections. However, such solutions have been found to significantly increase waste and manufacturing cost/time while also incurring automated construction complications.

Contrasting that of timber, bamboo (fibre) expansion is mostly longitudinal in nature—that is, expansion of a segment of bamboo occurs in a direction that is substantially aligned with the (general) fibre direction of the bamboo segment.

It has been found that when using bamboo as an inner part in a composite flooring panel structure, aligning the bamboo relative to the timber upper and lower layers such that the directions in which the respective components expand (and/or indeed contract) can result in a structure that can be said to be of improved balance and stability.

While producing a more stable structure, the configuration described herein has been found to also reduce manufacturing costs as wider inner part components can be used. Furthermore, automation of the manufacturing process has been found to be simpler with a more consistent substance used in the inner part, for example, having no knots, sapwood, heartwood, decay etc; the latter contributing negatively to the manufacturing assembly process and are often discarded and wasted for this reason.

As a result of the low-cost and availability of commonly used inner part and lower layer products, a compromise is made in the inherent strength of the products used. Softwood products generally have a low deflection strength and require increased thickness in order to provide sufficient strength to minimise or reduce movement such as, for example, cupping in flooring products. As products get wider they are made thicker in order to compensate for the increased stresses in the upper layer of the composite structure. A thicker product results in more volume of materials being required per square metre.

A bamboo inner part layer can be made so as to be more rigid for a given thickness. This will result in thinner boards for the same width compared to existing products and facilitates the use of less high cost raw materials per square metre, as compared to other high-strength alternatives such as, for example, hardwoods. Thinner boards also require less space for logistics and storage, have more appeal to customers, and are easier to install. As the deflection strength of bamboo is well above currently used materials, its use also allows new materials to be used in the upper layer of the sandwich structure that are currently not possible. Such materials may comprise high-density hardwoods like eucalyptus (which can now be reliably used at widths greater than 150 mm).

Current materials utilised in engineered floorboard design are predominantly highly processed timber products such as, for example, plywood. In general, these materials require large manufacturing and logistical processes in order to be ready to manufacture into the final flooring product. Softwoods and plywood like products are more susceptible to insect attack, from for example, borers, termites etc. and are easily distorted when subjected to water ingress/humidity.

Bamboo is a fast-growing, strong, and reliable crop that absorbs more carbon dioxide per hectare than equivalent trees. Using bamboo in the core or inner part of composite flooring products, for example, is likely to result in requiring less harvesting of trees, transport, and manufacturing of existing products. It follows that having an inner part of an engineered floorboard produced in a specialist factory, and then distributed to flooring factories direct, is likely to result in a simpler overall manufacturing process that is better for the environment.

Bamboo has a higher resistance to termites than most of the materials currently used in engineered floorboard design. The balanced expansion and contraction of the boards will allow the product to be used with underfloor heating. Costs are reduced in manufacturing and logistics. The floorboard is comprised of dense materials resulting in an increased feeling of quality to the consumer and it feels “solid” rather than “hollow”. Generally, the resulting floorboard is less susceptible to water ingress than competing products, more versatile than standard engineered flooring assets, having increased stability allows the inherent structure to be used in a more diverse range of applications.

For assembly purposes, an interlocking arrangement may be incorporated so as to allow adjacently positioned boards, panels, structures to be interlocked or secured in a desired relative positional configuration. For example, on the outer edges of the floorboard 5, a ‘tongue and groove’ arrangement 60) is typically provided which, in the embodiment shown, provides the floor board with an interlocking means for the purposes of allowing the relative positional securement. In this manner, such an interlocking means may allow the floorboard 5 to engage with, for example, another structure or like floorboard. The tongue and groove arrangement 60 runs along the entire length of the floorboard (refer FIG. 1—see strips 25, 30 which serve as components 60a, 60b of tongue and groove arrangement 60). It will be appreciated that the tongue and groove strips 60a, 60b can be made or provided from any suitable material. The skilled reader will appreciate that other forms of interlocking arrangements (being complementary in shape/form or otherwise) may be configured to operate with various embodiments of the composite substrate described herein.

In the embodiment shown, the first 10 (or upper) member of the floorboard 5 is a wear layer, and provides a surface which is visible after the floorboard has been installed. It will be appreciated that various coatings and finishes can be applied to the first 10 outer member according to customer/consumer preference. The skilled reader would appreciate that any suitable timber or bamboo material can be used as the first 10 and second 15 outer members of the floorboard 5 structure. In some proposed arrangements, for example, the second 15 (lower) outer member be plastic. It will also be appreciated that the common direction of expansion and contraction can be used where the top and bottom outer members 10 and 15 are bamboo while the inner member 20 is timber, as the timber when placed with fibre/grain direction transverse to the length L will expand or contract with the bamboo in a direction substantially parallel to the length L.

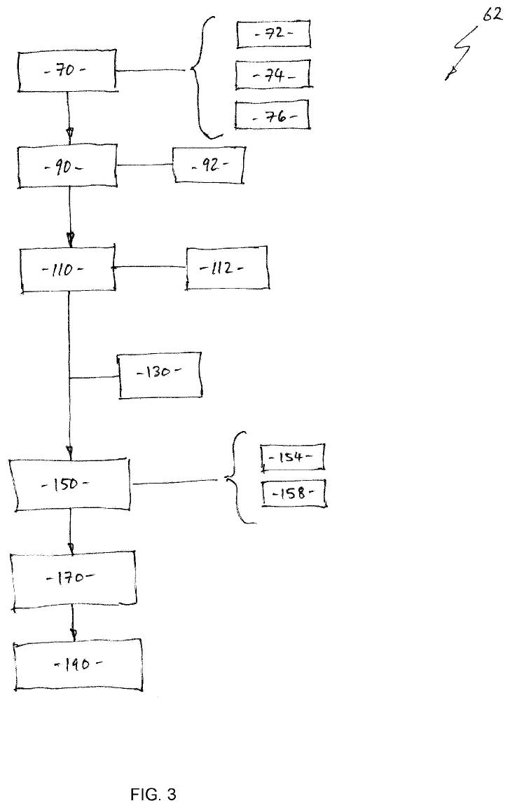

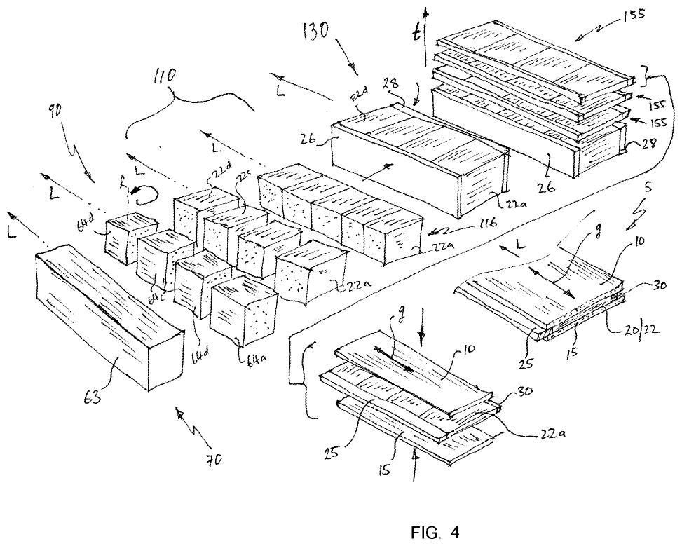

According to another aspect, the composite substrate described herein is produced by a new method, an embodiment of which (method 62) is shown in schematic form in FIGS. 3 and 4, and described below.

The method 62 involves providing a bamboo based orientated strand substrate 63 (shown at 70). In order to provide the bamboo based substrate 62 sufficient for present purposes, similar steps as used for the preparation and forming of orientated strand board can be employed. In this manner, raw bamboo material is compiled and undergoes the following processes:
(A) Soaking (72)—the bamboo fibres are soaked in resin (eg. a Phenolic resin) in order to increase fibre stability and water resistance.
(B) Orientation (74)—it is advantageous to orientate the bamboo fibres so that they align substantially parallel to surfaces that are potentially exposed to moisture—bamboo fibres draw considerably less moisture through the side of the fibre/grain direction than along the fibre/grain direction;
(C) Compression (76)—the bamboo fibres are compressed to achieve a high density substrate so as to reduce the water transfer properties (similar is also the case for wood).

Processes (A)-(C) could be performed in any order.

The resulting bamboo based oriented substrate 63 may be formed in an elongate shape (shown in FIG. 4) whereby a substantially uniform cross-section extends in the length direction L of the substrate 63. In the embodiment shown, the uniform cross-section is substantially rectangular.

The method 62 further comprises modifying the substrate 63 to provide more than one separate segments (collectively, 64) (shown at 90). The modification step 90 provides the plurality of segments 64 by cutting the bamboo based orientated strand substrate 63 perpendicularly (92) across the length direction L of the substrate 63. As shown in FIG. 4, each of the segments 22 are of substantially identical shape and form (eg. generally rectangular).

Cutting the laminations of the compressed bamboo segments 64 must be at right angles to the compression direction of the block mould. This ensures that any post cutting relaxation of the compressed fibres will not occur across the width of the layer or lamination, and therefore the length of the resulting substrate which could easily cause structural failure.

The method 62 further comprises combining the segments 64 so that respective fibre directions of the segments are aligned substantially parallel to each other (shown at 110). In this manner, alignment of the segments 64 comprises rotating (112) each of the segments about 90° so as to orientate the fibre directions of the respective segments so that they run across the (original) width (i.e. transverse to the length L direction) of the bamboo based orientated strand substrate 63. It is important that the compression direction not change in this step. This is achieved by the axis of rotation R of each segment 64 being parallel to the direction of compression.

Combination of the segments 64 (now combined segments 116) is undertaken in a manner providing an elongate shape with a substantially uniform cross-section (which, in one embodiment, may also be of rectangular form) extending in the length direction L. In this manner, the direction of the fibres of the respective segments 22 is substantially transverse to the direction of elongation of the combined segments 116 (ie. the length direction L).

The method 62 further comprises modifying the combined segments 116 (and strips 25, 30) to provide one or more separate layers 155, each separate layer comprising portions of each segment in a substantially planar relationship (shown at 150). In this manner, the combined segments 116 and strips 25, 30 (see discussion below) is divided 154 (for example, by backsaw cutting) in a thickness direction t to provide the respective separate layers 155. When cut in this manner, the direction of compression will be substantially parallel to the thickness direction t. Each of the separate layers 155 may be of uniform cross-section along their lengths. In one embodiment, the uniform cross-section is substantially rectangular in form. In one embodiment, the separate layers 155 are approximately 7 to 9 mm in thickness. Each of the separate layers 155 may be subject to thermal loading (such as, for example, in a kiln) in order to reduce moisture content, or pressure loading.

The layers 155 are suitable for transport to a different location to complete the manufacture of the floor board. This is advantageous as the manufacture of the layers can be more economical close to the source of the bamboo. However, the timber outer layers may be more economically attached close to the source of the particular type of timber used to form the outer layer.

The method 62 further comprises locating each of the separate layers 155 between first 10 and second 15 outer members in a manner whereby the direction of the fibres of the first and second outer members are aligned substantially transverse to the respective fibre directions of the segments 22 (shown at 170). Such location of the respective elements may comprise fixing said elements together using adhesive or mechanical fastening means. A precursor moisture balancing step with heating may occur before the separate layers 155 are located between the first 10 and the second 15 outer members.

Following location/fixing of the first 10 and second 15 outer members to respective layers 155, the combination of same may be subject (190) to any of the following: thermal loading (ie. drying in a kiln, for example) for reducing moisture content and balancing the board, appropriate treatment for the purposes of improving the performance and/or aesthetics of the outer facing surface of either of the first 10 or second 15 outer members (for example, for the case of a composite floorboard produced by way of method 62, the surface intended to be visible to the consumer, ie. first 10 outer member).

In some embodiments, the inner part 20 may be finished to an accuracy of about +−0.1 mm in a calibration sander before gluing.

The method 62 may advantageously comprise reusing any wastage resulting from any modification stage using cutting techniques in the formation of subsequent initial bamboo based substrates for the inner parts 20. This assists in realising a more cost effective manufacturing process.

Any other processes intended for achieving a desired finish of the floorboard 5 may be employed.

Following combining of the segments 22, the method 62 may further comprise locating one or more elements 26, 28 (which ultimately provide strips 25, 30 in the embodiment shown) against a side of the now combined segments 116 (shown at 130). In the embodiment shown, elements 26, 28 are located as required by being fixed (using, for example, adhesive) against the generally planar (opposite) sides of the combined segments 116 as shown in order to provide edge strips 25, 30 which, in turn, provides the components 60a, 60b of the tongue and groove arrangement 60. In this manner, the combined segments 116 are located in between strips 25, 30. As shown, the elements 26, 28 could comprise, for example, timber, plastic, or any suitable material to suit the intended application. In one embodiment, the material from which the elements 26, 28 is formed is selected based on its ability to resist water ingress.

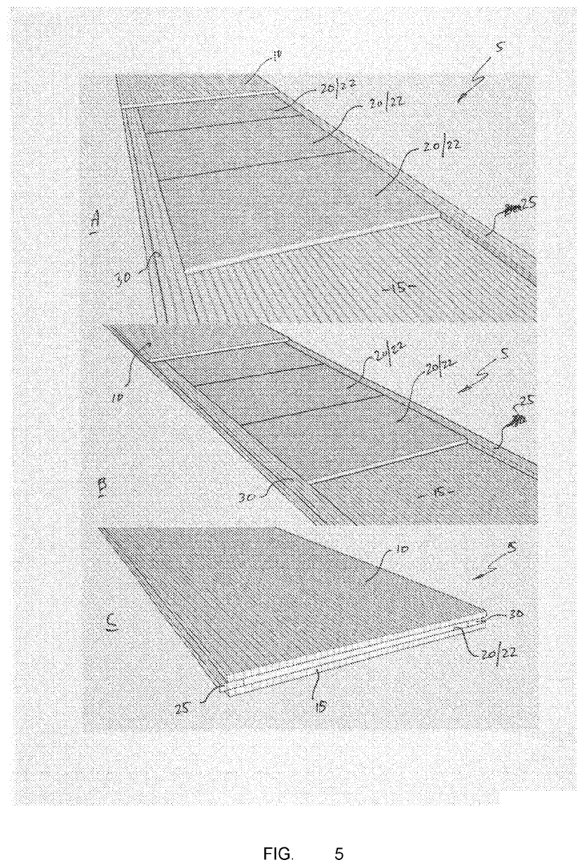

FIGS. 5A-5B shows various schematic views of the floorboard 5 formed using the configuration of the composite substrate described herein. FIG. 5A and Figure B showing the arrangement of the segments 22 of the inner part 20, and FIG. 5C showing an end view of the complete sandwich structure.

As noted above, embodiments exemplified herein seek to result in a more cost-effective composite substrate (for example, for use in producing a floorboard or other like construction panel) exhibiting any of the following advantages: the substrate providing improved strength by design, being thinner and its thickness (as compared to solid and traditional manufacturing of engineered panels/boards), requiring less hardwoods resource, being more termite and moisture resistance, and/or being more appealing to the consumer, including because some embodiments of the floor board of the present invention is less pliable or less prone to deflection as compare to the same thickness of a traditional floor board and it able to emulate a solid wood floor board in weight fell and look.

The foregoing description illustrates various aspects and examples of the present disclosure. It is not intended to be exhaustive. Rather, it is chosen to illustrate the principles the subject of the present disclosure and their practical application to enable one of ordinary skill in the art to utilize the present disclosure, including its various modifications that naturally follow. All modifications and variations are contemplated within the scope of the present disclosure as determined by the appended claims. Relatively apparent modifications and/or variations include combining one or more features of various embodiments with features of other embodiments.

Throughout the specification and claims that follow, unless the context requires otherwise, the terms “substantially” or “about” will be understood to not be limited to the value for the range qualified by the terms.

Throughout the specification and claims that follow, unless the context requires otherwise, the word “comprise” or variations such as “comprises” or “comprising”, will be understood to imply the inclusion of a stated integer or group of integers but not the exclusion of any other integer or group of integers.

Throughout the specification and claims that follow, unless the context requires otherwise, the word “include” or variations such as “includes” or “including”, will be understood to imply the inclusion of a stated integer or group of integers but not the exclusion of any other integer or group of integers.

1. A composite substrate comprising:
an inner part arranged intermediate first and second outer members at least one of which is made of a first material, the inner part comprising more than one segments of a second material with different material properties to the first material, the segments being orientated so that fibres of at least one segment of the second material align substantially transverse to fibres of the first material of one or both of the first and second outer members, the relative alignment of the respective fibres serving to, at least in part, align the majority of deformation of the segments with the majority of deformation of at least one of the first and second outer members in a substantially common direction due to environmental conditions.

2. A composite substrate according to claim 1, wherein the second material is wood.

3. A composite substrate comprising one or more inner parts of a bamboo material arranged intermediate first and second outer members at least one of which is made of a wooden material, each inner part being orientated relative to the first, second outer members such that respective directions in which each inner parts and the first, second outer members may physically respond to environmental conditions are substantially aligned.

4. A composite substrate according to claim 1, wherein one or both of the first and second outer members physically respond to environmental conditions substantially in a direction not substantially aligned with a fibre direction of the respective first, second outer members.

5. A composite substrate according to claim 1, wherein one or more of the segment of the inner part physically respond to environmental conditions substantially in a direction substantially aligned with a fibre direction of each respective segment.

6. A composite substrate according to claim 1, wherein the segment of the inner part and first, second outer members comprise respective layers of bamboo material combined together to form the composite substrate with all of the fibres of the bamboo material substantially having the same alignment.

7. A composite substrate according to claim 1, wherein the segment of the inner part comprises:
(i) a high-density bamboo based substrate; or
(ii) bamboo based orientated strand board.

8. A composite substrate according to claim 1, wherein the composite substrate comprises a pair of elements disposed at least partially between the first and second outer members and arranged against opposite sides of a portion of the segment of the inner part in a substantially co-planar manner.

9. A composite substrate according to claim 8, wherein a portion of each segments or portions of the inner part is located intermediate the pair of elements.

10. A composite substrate according to claim 1, wherein the composite substrate comprises one or more components of an interlocking arrangement for allowing relative positional securement relative a further panel.

11. A composite substrate according to claim 10, wherein one or both of the pair of elements is a component of the interlocking arrangement.

12. A composite substrate according to claim 9, wherein the interlocking arrangement is provided in the form of a tongue and groove arrangement allowing like configured floorboards to be interlocked or secured to each other for providing a flooring assembly.

13. A composite substrate according to claim 1, wherein expansion or contraction of the first and second outer members, or one or more segment of the inner part is in response to the first, second members, or the one or more segment of the inner part becoming subject to any of the following: a thermal load, moisture, humidity or water.

14. A composite substrate according to claim 1, wherein expansion or contraction of the inner part is substantially only transverse to the length of the composite substrate and expansion or contraction of the first and second outer members is also substantially only transverse to the length of the composite substrate, and/or
wherein expansion or contraction of the inner part is greatest transverse to the length of the composite substrate and expansion or contraction of the first and second outer members is greatest transverse to the length of the composite substrate.

15. A composite substrate according to claim 1, wherein the composite substrate can be configured to be of selected thickness or length.

16. A substrate comprising a length, a width and a thickness; a pair of edge strips running the length of the substrate, and which define the width of the substrate, and which have a height that defines the thickness of the substrate; a plurality of segments extending between, and adhered to, the edge strips in a manner so as to be side by side along the length of the substrate; wherein the strips have a height substantially the same as the thickness of the substrate; wherein the segments are formed of bamboo, and have a fibre direction extending transversely to the length of the substrate; wherein the strips have a direction of the majority of expansion due to compression relaxation that is substantially transverse to the fibre direction and transverse to the length of the substrate.

17. A substrate according to claim 16, wherein a layer of wood is attached to one or more major surfaces of the substrate, and wherein the grain of the wood extends substantially parallel to the length of the substrate.

18. A substrate according to claim 17, wherein a top layer of visually first grade wood is attached to a first major surface of the substrate.

19. A substrate according to claim 16, wherein a bottom layer of visually second grade wood is attached to an opposite second major surface of the substrate.

20-38. (canceled)

39. A floor board comprising:
a bamboo based core comprising a pair of edge strips running a length of the floor board; a plurality of segments extending between, and adhered to, the edge strips in a manner so as to be side by side along the length of the floor board; wherein the segments are formed of compressed bamboo, and have a fibre direction extending transversely to the length of the floor board; wherein the strips have a direction of expansion due to compression relaxation that is transverse to the fibre direction and transverse to the length of the floor board; wherein the strips have a direction of expansion or contraction substantially as a result of environmental conditions that is substantially transverse to the length of the floor board,
a first outer timber member having fibres that are aligned substantially transverse to the respective fibre directions of the segments, wherein expansion or contraction of one or both of the first outer member substantially as a result of environmental conditions is substantially transverse to the length of the floor board; and
a second outer member on an opposite side of the floor board to the first outer member.

40. A floor comprising a covering of a plurality of composite wooden laminate panels comprising, at least in part, any embodiment of a composite substrate operably configured according to claim 1.

41. (canceled)

42. A composite substrate according to claim 3, wherein the one or more inner parts comprise a segment or a plurality of substantially parallel segments.
